(19) United States
(12) Patent Application Publication
(10) Pub. No.: US 2025/0137789 A1
(43) Pub. Date: May 1, 2025

(54) APPARATUS AND METHOD FOR GENERATING PATH CONSIDERING SIGNAL WAITING TIME

(71) Applicants: Hyundai Motor Company, Seoul (KR); Kia Corporation, Seoul (KR)

(72) Inventors: Soo Yeon Shin, Seoul (KR); Taehyun Sung, Seoul (KR)

(21) Appl. No.: 18/607,720

(22) Filed: Mar. 18, 2024

(30) Foreign Application Priority Data
Oct. 25, 2023 (KR) 10-2023-0143622

(51) Int. Cl. G01C 21/34; G01C 21/32

(52) U.S. Cl. CPC G01C 21/3461; G01C 21/32; G01C 21/3492

(57) ABSTRACT

An apparatus for generating a route considering a traffic light waiting time may include a vehicle location determining unit configured to determine a location of a user vehicle travelling on a first route and identify a first traffic signal on the first route, a traffic light waiting time prediction unit configured to determine a first traffic light waiting time based on a signal change data for the first traffic signal and vehicle movement data of vehicles having entered a waiting queue of the first traffic signal, an estimated arrival time determining unit configured to determine a first estimated arrival time based on the first traffic light waiting time, and a route generating unit configured to generate a second route providing a second traffic light waiting time and a second estimated arrival time based on the waiting queue database.

### CROSS-REFERENCE TO RELATED APPLICATIONS

This application claims the benefit of Korean Patent Application No. 10-2023-0143622, filed on Oct. 25, 2023, which application is hereby incorporated herein by reference.

### TECHNICAL FIELD

The present disclosure relates to an apparatus and method for generating a route considering a traffic light waiting time.

### BACKGROUND

Navigation is a system that provides guidance to the destination by providing optimal route guidance to the driver in the vehicle. Navigation provides various route search options, such as minimum time and shortest distance to the user's desired destination, and guides the user to the desired route.

When there is severe congestion at traffic lights, such as a bottleneck or at an intersection with very short left/right-turn lights, there are frequent cases of waiting in the queue lane for a long time (several signal cycles) before passing the signal and then entering the normal lane. In this case, the estimated time of arrival (ETA) (hereinafter referred to also as estimated arrival time) gradually increases by the minute due to unexpected traffic light waiting. If a driver fails to enter the lane in advance, e.g., without recognizing the long queue, situations such as accidents due to excessive cutting in, fines imposed, and increased arrival time due to unintentional detours may occur. To the contrary, even though a driver has waited in the signal queue, there may be situations where such waiting in the queue is unnecessary because it was an adjacent lane instead of the actual lane for entry.

Existing navigation systems do not provide detailed information on queuing conditions according to signals (queuing information on each lane, etc.).

### SUMMARY

The present disclosure relates to an apparatus and method for generating a route considering a traffic light waiting time. More particularly, the present disclosure relates to an apparatus and method for generating a route considering a traffic light waiting time capable of generating an optimal route minimizing an estimated traffic light waiting time on a route.

An embodiment of the present disclosure can provide an apparatus and method for generating a route considering a traffic light waiting time capable of generating an optimal route providing a precise estimated arrival time (ETA) while minimizing traffic light waiting time of the driver by calculating estimated traffic light waiting time with respect to a traffic signal on the route, and considering the calculated estimated traffic light waiting time.

An embodiment of the present disclosure can provide an apparatus and method for generating a route considering a traffic light waiting time capable of, when waiting time of a particular traffic signal on the travelling route of the vehicle is long, or when the traffic signal has been changed immediately previously in the situation both directions are drivable, by searching more routes around an instant driving lane, if there is no significant difference in the estimated arrival time, guiding a route that does not pass through a traffic signal having a long waiting queue or exit to a route of a drivable traffic light.

An apparatus for generating a route considering a traffic light waiting time may include a route setting unit configured to set a first route for a destination input by a user through a navigation system, a vehicle location determining unit configured to determine a location of a user vehicle travelling on the first route by using a global navigation satellite system (GNSS) and identify a first traffic signal to be subsequently entered on the first route based on the location of the user vehicle, a traffic light waiting time prediction unit configured to calculate in real time a first traffic light waiting time expected after the user vehicle enters the waiting queue of the first traffic signal based on a signal change data for the first traffic signal and a vehicle movement data of vehicles having entered a waiting queue of the first traffic signal and store the calculated first traffic light in a waiting queue database, an estimated arrival time calculating unit configured to calculate a first estimated arrival time for the destination of the user vehicle based on the first traffic light waiting time, and a route generating unit configured to generate a second route providing a second traffic light waiting time shorter than the first traffic light waiting time and a second estimated arrival time not later than the first estimated arrival time based on the waiting queue database.

The vehicle location determining unit may be configured to determine the location of the user vehicle on a lane-by-lane basis through precise positioning and a map matching method based on the GNSS.

The waiting queue database may be configured to collect information on a plurality of traffic signals on the first route and the second route and waiting queue information on each of the plurality of traffic signals from a plurality of vehicles and store the collected information in real time.

The waiting queue information on each of the plurality of traffic signals may include green light waiting queue information, left-turn light waiting queue information, and right-turn light waiting queue information of each of the plurality of traffic signals.

The traffic light waiting time prediction unit may be configured to calculate in real time the first traffic light waiting time for one waiting queue guided on the first route among a green light waiting queue, a left-turn light waiting queue, and a right-turn light waiting queue of the first traffic signal.

The route generating unit may be configured to retrieve the second traffic light waiting time with respect to remaining waiting queues excluding the one waiting queue of the first traffic signal from the waiting queue database and compare the retrieved second traffic light waiting time with the first traffic light waiting time.

The route generating unit may be configured to extract a plurality of second traffic signals having the second traffic light waiting time shorter than the first traffic light waiting time for the waiting queue of the first traffic signal, based on a plurality of routes to the destination, and provide a route to subsequently enter one second traffic signal located on the second route providing the second estimated arrival time among the extracted the plurality of second traffic signals.

The estimated arrival time calculating unit may be configured to, when the calculated first traffic light waiting time is greater than a reference traffic light waiting time by a preset criterion or more, determine that a delay time has occurred in the waiting queue, and calculate the first estimated arrival time by reflecting the delay time.

The estimated arrival time calculating unit may be configured to update the existing estimated destination arrival time by using the calculated estimated destination arrival time, and provide a first notification about the waiting queue and the delay time occurring in the waiting queue to the user through the navigation system.

The route generating unit may be configured to, when the delay time occurs, provide a second notification for guiding the second route as a recommended route together with the first notification to the user.

A method for generating a route considering a traffic light waiting time may include setting a first route for a destination input by a user through a navigation system, determining a location of a user vehicle travelling on the first route by using a GNSS and identify a first traffic signal to be subsequently entered on the first route based on the location of the user vehicle, calculating in real time a first traffic light waiting time expected after the user vehicle enters the waiting queue of the first traffic signal based on signal change data for the first traffic signal and a vehicle movement data of vehicles having entered a waiting queue of the first traffic signal and storing the calculated first traffic light waiting time in a waiting queue database, calculating a first estimated arrival time for the destination of the user vehicle based on the first traffic light waiting time, and generating a second route providing second traffic light waiting time shorter than the first traffic light waiting time and a second estimated arrival time not later than the first estimated arrival time based on the waiting queue database.

The determining the location of the user vehicle may include determining the location of the user vehicle on a lane-by-lane basis through precise positioning and a map matching method based on the GNSS.

The waiting queue database may be configured to collect information on a plurality of traffic signals on the first route and the second route and waiting queue information on each of the plurality of traffic signals from a plurality of vehicles and store the collected information in real time.

The waiting queue information on each of the plurality of traffic signals may include green light waiting queue information, left-turn light waiting queue information, and right-turn light waiting queue information of each of the plurality of traffic signals.

The calculating in real time of the first traffic light waiting time and storing the calculated first traffic light waiting time in the waiting queue database may include calculating in real time the first traffic light waiting time for one waiting queue guided on the first route among a green light waiting queue, a left-turn light waiting queue and a right-turn light waiting queue of the first traffic signal.

The generating of the second route may include retrieving the second traffic light waiting time with respect to remaining waiting queues excluding the one waiting queue of the first traffic signal from the waiting queue database and comparing the retrieved second traffic light waiting time with the first traffic light waiting time and generating the second route.

The generating of the second route may include extracting a plurality of second traffic signals having the second traffic light waiting time shorter than the first traffic light waiting time for the waiting queue of the first traffic signal, based on a plurality of routes to the destination, and providing a route to subsequently enter one second traffic signal located on the second route providing the second estimated arrival time among the extracted plurality of second traffic signals.

The calculating of the first estimated arrival time may include determining, when the calculated first traffic light waiting time is greater than a reference traffic light waiting time by a preset criterion or more, that a delay time has occurred in the waiting queue, and calculating the first estimated arrival time by including the delay time.

The calculating of the first estimated arrival time may further include updating the existing estimated destination arrival time by using the calculated estimated destination arrival time, and providing a first notification about the waiting queue and the delay time occurring in the waiting queue to the user through the navigation system.

The generating of the second route may include, when the delay time occurs, providing a second notification for guiding the second route as a recommended route together with the first notification to the user.

An apparatus and method for generating a route considering a traffic light waiting time according to an embodiment may generate an optimal route providing a precise estimated arrival time (ETA) while minimizing traffic light waiting time of the driver by calculating estimated traffic light waiting time with respect to a traffic signal on the route, and considering the calculated estimated traffic light waiting time.

An apparatus and method for generating a route considering a traffic light waiting time according to an embodiment may, when a waiting time of a particular traffic signal on the travelling route of the vehicle is long, or when the traffic signal has been changed immediately previously in the situation for which both directions are drivable, by searching more routes around instant driving lane, if there is no significant difference in the estimated arrival time, guide a route that does not pass through a traffic signal having a long waiting queue or exit to a route of drivable traffic light.

### BRIEF DESCRIPTION OF THE DRAWINGS

FIG. 1 is a diagram schematically showing a system for generating a route considering a traffic light waiting time according to an embodiment.

FIG. 2 is a drawing showing a waiting queue database according to an embodiment.

FIG. 3 is a block diagram of an apparatus for generating a route considering a traffic light waiting time according to an embodiment.

FIG. 4 is a flowchart of a method for generating a route considering a traffic light waiting time according to an embodiment.

FIG. 5 is a drawing for explaining that an apparatus for generating a route considering a traffic light waiting time according to an embodiment may calculate a traffic light waiting time and an estimated arrival time.

FIG. 6 is a drawing for explaining that an apparatus for generating a route considering a traffic light waiting time according to an embodiment may generate an optimal route.

FIG. 7 is a flowchart of a method for generating a route considering a traffic light waiting time according to an embodiment.

FIG. 8 is a drawing for explaining a computing device according to an embodiment.

### DETAILED DESCRIPTION OF ILLUSTRATIVE EMBODIMENTS

Embodiments of the present disclosure are described more fully hereinafter with reference to the accompanying drawings such that a person skill in the art may easily implement an embodiment. As those skilled in the art can realize, the described embodiments may be modified in various different ways without departing from the spirit or scope of the present disclosure. To clarify the present disclosure, parts that are not related to the description can be omitted, and same elements or equivalents can be referred to with same reference numerals throughout the specification.

In addition, unless explicitly described to the contrary, the word “comprise” and variations such as “comprises” or “comprising” can be understood to imply the inclusion of stated elements but not the exclusion of any other elements. Terms including an ordinary number, such as “first” and “second,” can be used for describing various constituent elements, but the constituent elements are not necessarily limited by such terms. Such terms can be merely used to differentiate one component from other components.

In addition, the terms “unit,” “part” or “portion,” “-er,” and “module” in the specification can refer to a unit that processes at least one function or operation, which may be implemented by hardware, software, or a combination of hardware and software.

Hereinafter, embodiments of the present disclosure will be described with reference to the drawings.

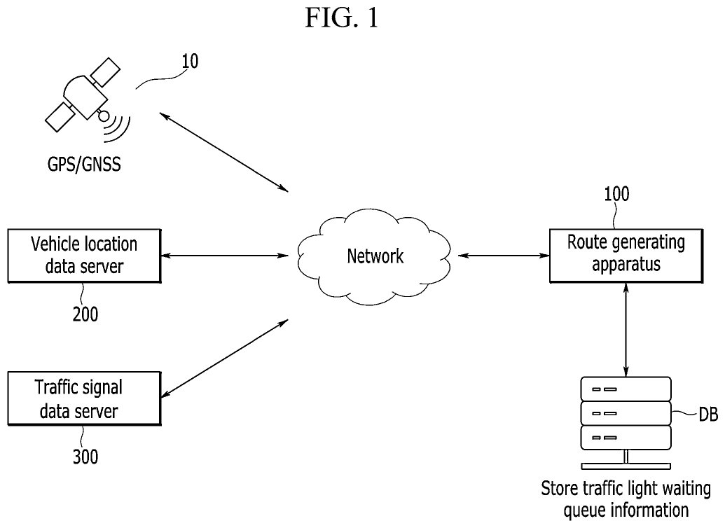

FIG. 1 is a diagram that schematically shows a system for generating a route considering a traffic light waiting time according to an embodiment.

Referring to FIG. 1, a route generation system may include a GPS/GNSS 10, an apparatus 100 for generating a route considering the traffic light waiting time (hereinafter, called a route generating apparatus 100), a vehicle location data server 200, a traffic signal data server 300 and a waiting queue database DB.

The GPS/GNSS 10 can provide a global positioning system (GPS) or a global navigation satellite system (GNSS). The GPS/GNSS 10 can be a global positioning information service system, and can provide precise positioning information to anyone, anywhere, at any time by using radio waves transmitted from satellites. The GPS/GNSS 10 can provide positioning information about a user vehicle and other vehicles to the vehicle location data server 200 and the route generating apparatus 100 through a network.

The route generating apparatus 100 may predict the traffic light waiting time of the traffic signal in an entry route of the user vehicle based on the waiting queue database including the traffic signal and vehicle movement information uploaded in real-time.

The route generating apparatus 100 may generate an optimal route to the destination of which the traffic light waiting time is minimal, and the estimated arrival time is minimal based on an estimated destination arrival time of the user vehicle calculated in consideration of the predicted traffic light waiting time and the traffic light waiting time.

The vehicle location data server 200 may provide location and movement information of the vehicle to the route generating apparatus 100. The vehicle location data server 200 may provide movement information on not only the user vehicle but also other vehicles on the route. The vehicle location data server 200 may collect location data and movement data of the vehicles in real time from the GPS/GNSS 10 and store the same.

The traffic signal data server 300 may provide information on the traffic signal to the route generating apparatus 100. The traffic signal data server 300 may provide a signal change data of the traffic signals on the route of the user vehicle. For example, the traffic signal data server 300 may be an intelligent transport systems (ITS) server.

The waiting queue database DB may store information on the waiting queue of the traffic signals on the route. The waiting queue database DB may store information on the traffic light waiting time of each of the traffic signals collected from the vehicles. For example, the waiting queue database DB may collect information on a plurality of traffic signals on different first and second routes and waiting queue information on each of the plurality of traffic signals from a plurality of vehicles and store the collected information in real time.

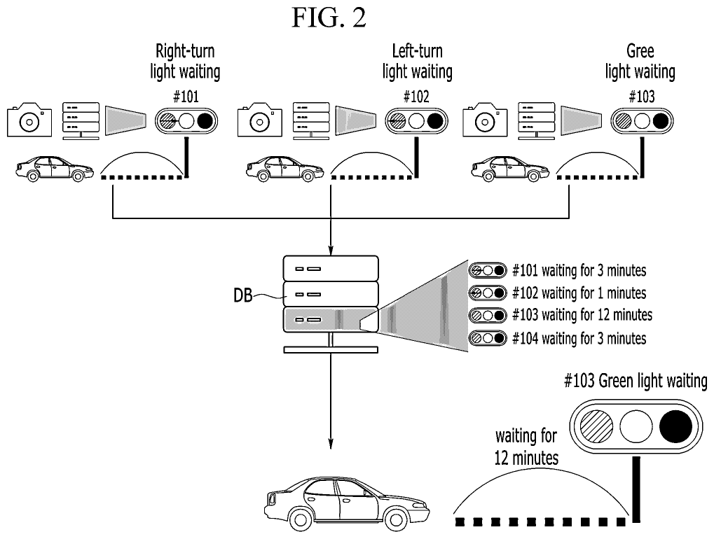

FIG. 2 is a drawing showing a waiting queue database according to an embodiment. FIG. 2 shows the traffic light waiting time information on the waiting queue of the traffic signal obtained through the waiting queue database DB.

The waiting queue information on the traffic signal may include green light waiting queue information, a left-turn light waiting queue information, and right-turn light waiting queue information.

The route generating apparatus 100 may calculate the traffic light waiting time for the green light waiting queue of the traffic signal to be subsequently entered on the current route by the user vehicle, and store the calculated waiting time in the waiting queue database DB (refer to FIG. 1).

The route generating apparatus 100 may collect the traffic light waiting time for all the waiting queues including other waiting queues of the traffic signal from the waiting queue database DB. When the estimated arrival time is excessively increased by the green light waiting queue on the current route, the route generating apparatus 100 may generate another route of which the estimated arrival time is not increased based on the traffic light waiting times for the collected other waiting queues.

In FIG. 2, when the traffic light waiting time of the waiting queue of an immediately previous signal #103 is 12 minutes, the traffic light waiting time of the waiting queue of the left-turn light #102 is 1 minute, the route generating apparatus 100 may generate a new route entering a left-turn waiting queue and provide it to the user.

For example, when the traffic light waiting time of the waiting queue of a right-turn light #101 is 3 minutes and the estimated arrival time is smaller on a route passing through the waiting queue of the right-turn light #101 than on a route passing through the waiting queue of the left-turn light #102, the route generating apparatus 100 may generate the route passing through the waiting queue of the right-turn light #101 and provide it to the user.

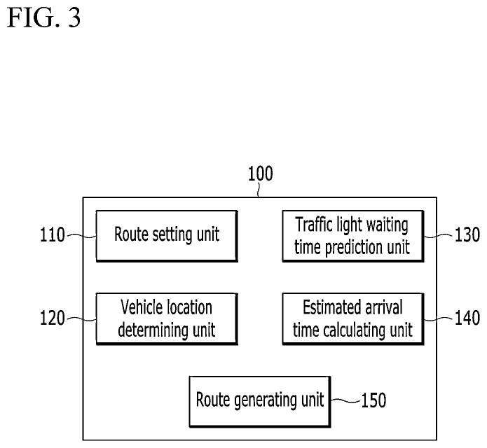

FIG. 3 is a block diagram of an apparatus for generating a route considering the traffic light waiting time according to an embodiment.

Referring to FIG. 3, the route generating apparatus 100 may include a route setting unit 110, a vehicle location determining unit 120, the traffic light waiting time prediction unit 130, an estimated arrival time calculating unit 140 and a route generating unit 150.

The route setting unit 110 may set a route to the destination input by the user through a navigation system. The route setting unit 110 may provide information on a selected, preset, stored, or predetermined route to the vehicle location determining unit 120.

The vehicle location determining unit 120 may determine a location of the user vehicle travelling on the route by using the GNSS, and identify the traffic signal to be subsequently entered on the route based on the location of the user vehicle.

The vehicle location determining unit 120 may determine the location of the user vehicle on a lane-by-lane basis through precise positioning and a map matching method based on the GNSS. For example, the vehicle location determining unit 120 may determine the location with the accuracy of about 30 cm based on an open area by utilizing precise positioning, the map matching method, and the GNSS correction information. The vehicle location determining unit 120 may update data including the determined vehicle location, speed, or the like in real time.

The vehicle location determining unit 120 may identify the traffic signal to be subsequently entered by the user vehicle among the traffic signals on the route through image recognition or the traffic signal data server 300 (refer to FIG. 1) of the user vehicle. The vehicle location determining unit 120 may know an exact location of the traffic signal that appears in front and the change state of the traffic signal based on image recognition of the vehicle and/or the traffic signal data received from the ITS server.

The traffic light waiting time prediction unit 130 may calculate in real time the traffic light waiting time expected after the user vehicle enters the waiting queue of the traffic signal based on the signal change data for the traffic signal and a vehicle movement data of vehicles having entered the waiting queue of the traffic signal, and store the waiting queue in the database DB (refer to FIG. 1).

The traffic light waiting time prediction unit 130 may collect the vehicle location and movement data of vehicles having entered the traffic signal through the vehicle location data server 200 (refer to FIG. 1) to which information on the locations of the vehicles on the route can be uploaded in real time.

The traffic light waiting time prediction unit 130 may collect the signal change data of the traffic signal through the traffic signal data server 300. For example, the traffic light waiting time prediction unit 130 may collect data about the traffic signal from the ITS server in real time.

The traffic light waiting time prediction unit 130 may detect an entry of the user vehicle into the waiting queue of the traffic signal based on whether the user vehicle has entered a particular lane designated to the waiting queue. The vehicle location determining unit 120 may know whether the waiting queue (traffic light waiting lane) has been entered based on the location and route of the vehicle on a lane-by-lane basis and destination information.

The traffic light waiting time prediction unit 130 may predict the traffic light waiting time based on a signal change period of the traffic signal and an average movement distance of the vehicles in the waiting queue during a signal change period.

The traffic light waiting time prediction unit 130 may, when the entry of the user vehicle into the waiting queue of the traffic signal is detected, based on the location of the user vehicle, provide notification about the traffic light waiting time calculated in real time to the user.

The traffic light waiting time prediction unit 130 may calculate in real time the traffic light waiting time for one waiting queue guided on the route among a green light waiting queue, a left-turn light waiting queue, and a right-turn light waiting queue of the traffic signal.

The estimated arrival time calculating unit 140 may calculate the estimated destination arrival time of the user vehicle based on the traffic light waiting time.

The estimated arrival time calculating unit 140 may, when the calculated traffic light waiting time is greater than a reference traffic light waiting time by a preset criterion or more, determine that a delay time has occurred in the waiting queue, and calculate the estimated destination arrival time by reflecting or incorporating the delay time.

The estimated arrival time calculating unit 140 may update the existing estimated destination arrival time by using the calculated the estimated destination arrival time. The estimated arrival time calculating unit 140 may provide information on the delay time occurring in the waiting queue and the waiting queue to the user through the navigation system.

The estimated arrival time calculating unit 140 may update the existing estimated destination arrival time by using the calculated estimated destination arrival time, and provide notification about the waiting queue and the delay time occurring in the waiting queue to the user through the navigation system.

The route generating unit 150 may, based on the waiting queue database DB, provide the traffic light waiting time shorter than the existing traffic light waiting time and generate a new route providing the estimated arrival time equal to or earlier than the existing estimated arrival time.

The route generating unit 150 may detect the traffic light waiting times for remaining waiting queues excluding the one waiting queue guided on the existing route among the green light waiting queue, the left-turn light waiting queue, and the right-turn light waiting queue of the traffic signal from the waiting queue database DB, and compare it with the traffic light waiting time of the one waiting queue on the existing route.

For example, the route generating unit 150 may compare the traffic light waiting time of the existing green light waiting queue and the traffic light waiting time of a new left-turn light waiting queue, and when the traffic light waiting time of the waiting queue of the left-turn light is shorter, generate the new route passing through the left-turn light waiting queue as the optimal route. When the estimated arrival time of the new route passing through the left-turn light waiting queue is earlier than or equal to the existing estimated arrival time, the route generating unit 150 may generate the new route as the optimal route.

In an embodiment, the route generating unit 150 may extract a plurality of second traffic signals having a second traffic light waiting time shorter than a first traffic light waiting time for the waiting queue of a first traffic signal, based on a plurality of routes to the destination.

The route generating unit 150 may provide a route to subsequently enter one second traffic signal located on the new route providing the estimated arrival time earlier than the existing estimated arrival time among the extracted plurality of second traffic signals.

When the delay time due to the traffic light waiting time on the existing route occurs, the route generating unit 150 may provide a notification for guiding the new route as a recommended route to the user as well as a notification about occurrence of the delay.

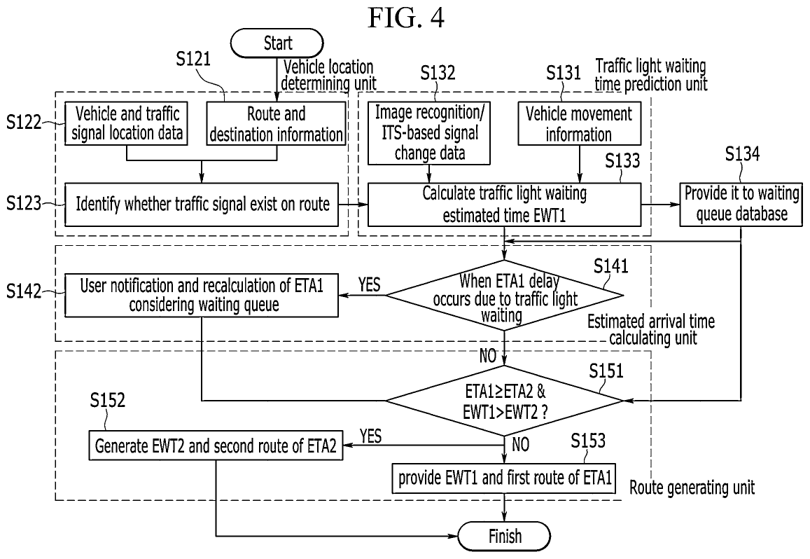

FIG. 4 is a flowchart of a method for generating a route considering a traffic light waiting time according to an embodiment.

In FIG. 4, at operation S121, the vehicle location determining unit 120 may receive route and destination information from the navigation system.

At operation S122, the vehicle location determining unit 120 may receive vehicle and traffic signal location data from the vehicle location data server 200 and the traffic signal data server 300.

At operation S123, the vehicle location determining unit 120 may identify whether the traffic signal exists on the route by using the received route, the destination information, the vehicle and traffic signal location data.

At operation S131, the traffic light waiting time prediction unit 130 may receive the vehicle movement information from the GPS/the GNSS 10 and the vehicle location data server 200.

At operation S132, the traffic light waiting time prediction unit 130 may receive image recognition and ITS-based signal change data.

At operation S133, the traffic light waiting time prediction unit 130 may calculate the first traffic light waiting time EWT1 for the first traffic signal by prediction using the signal change data and the vehicle movement information.

At operation S134, the traffic light waiting time prediction unit 130 may store the calculated first traffic light waiting time in the waiting queue database DB.

At operation S141, the estimated arrival time calculating unit 140 may determine whether a delay of a first estimated arrival time ETA1 has occurred due to traffic light waiting by using a first traffic light waiting estimated time.

At operation S142, when it is determined that the delay of the first estimated arrival time ETA1 has occurred, the estimated arrival time calculating unit 140 may provide an alarm for the occurrence of the delay to the user, and the first estimated arrival time ETA1 due to the delay.

At operation S151, the route generating unit 150 may determine whether the second traffic signal or another waiting queue of the first traffic signal having a second estimated arrival time ETA2 not later than the first estimated arrival time ETA1 and having the second traffic light waiting time EWT2 shorter than the first traffic light waiting time EWT1 exist. In an embodiment of the present disclosure, the second estimated arrival time ETA2 being less than or equal to the first estimated arrival time ETA1 can be indicating that the second estimated arrival time ETA2 is earlier then or the same as the first estimated arrival time ETA1.

At operation S152, when the second traffic signal or another waiting queue of the first traffic signal having the second estimated arrival time ETA2 and the second traffic light waiting time EWT2 exist, the route generating unit 150 may generate the second route that passes through it.

At operation S153, when the second traffic signal or another waiting queue of the first traffic signal does not exist, the route generating unit 150 may generate the first route having the first traffic light waiting time EWT1 and the first estimated arrival time ETA1 and provide it to the user.

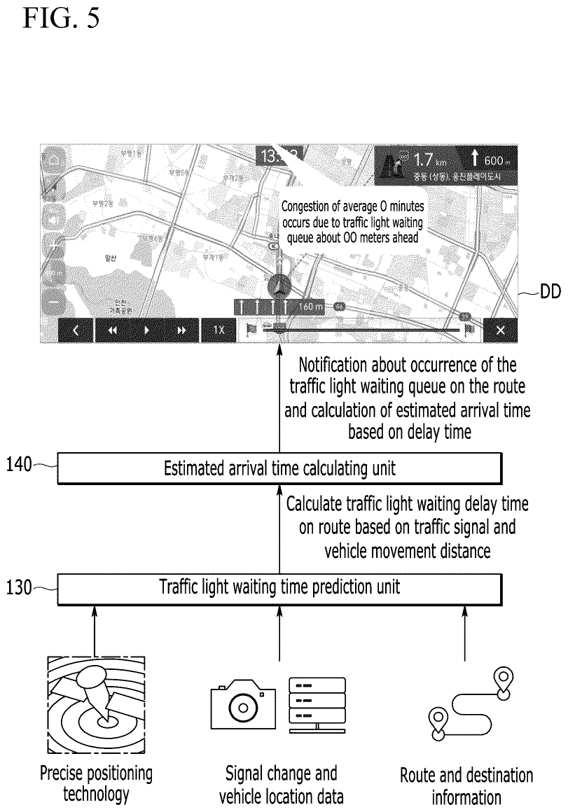

FIG. 5 is a drawing for explaining that an apparatus for generating a route considering the traffic light waiting time according to an embodiment that calculates the traffic light waiting time and the estimated arrival time.

In FIG. 5, the traffic light waiting time prediction unit 130 may calculate the traffic light waiting time and the delay time on the route by using precise positioning technology and signal change and vehicle location data and route and destination information based on the GNSS.

The estimated arrival time calculating unit 140 may calculate the estimated arrival time reflecting or including the delay time together with a notification about traffic light waiting queue on the route by using the traffic light waiting time calculated by the traffic light waiting time prediction unit 130 and the delay time therefrom.

The estimated arrival time calculating unit 140 may update the estimated arrival time in real time, and may notify information on the waiting queue ahead to the user through a display DD within the vehicle. The estimated arrival time calculating unit 140 may visually and/or audibly provide the position of the waiting queue ahead and the delay time due to the waiting queue to the user through the display DD.

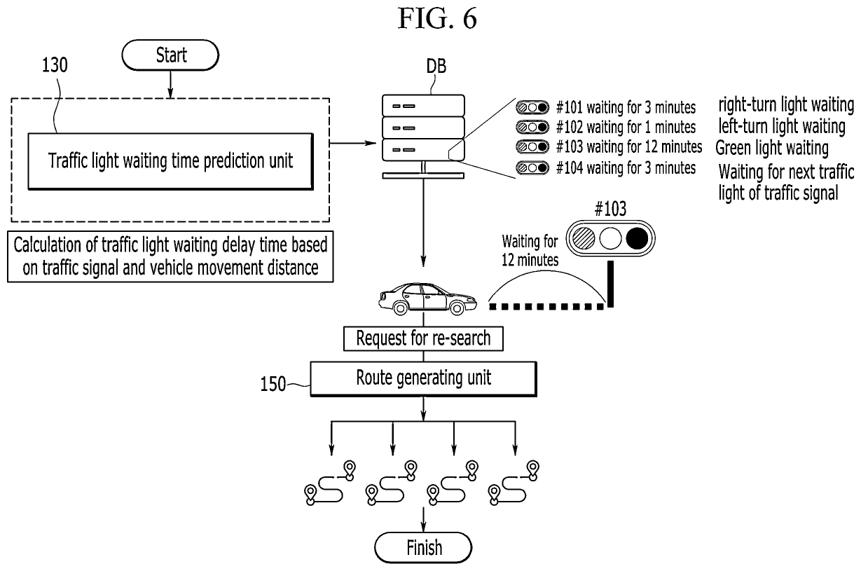

FIG. 6 is a drawing for explaining that an apparatus for generating a route considering the traffic light waiting time according to an embodiment generates the optimal route.

In FIG. 6, the traffic light waiting time prediction unit 130 may calculate the traffic light waiting time and the delay time based on information on the traffic signal and information on the vehicle movement distance. The traffic light waiting time prediction unit 130 may store the traffic light waiting time for the waiting queue of the traffic signal calculated in real time in the waiting queue database DB.

For example, the traffic light waiting time prediction unit 130 may calculate the traffic light waiting time for each of the right-turn light waiting queue #101, the left-turn light waiting queue #102, and the green light waiting queue #103 of the first traffic signal, and store it in the waiting queue database DB.

For example, the traffic light waiting time prediction unit 130 may calculate the traffic light waiting time of the green light waiting queue #103 as 12 minutes. The traffic light waiting time prediction unit 130 may determine that the delay time has occurred, according to the traffic light waiting time of the 12 minutes.

The route generating unit 150 may detect a route passing through another waiting queue or another traffic signal having a traffic light waiting time shorter than the traffic light waiting time of the 12 minutes. The route generating unit 150 may generate a route having a smallest estimated arrival time among a plurality of routes passing through another waiting queue and/or another traffic signal having a traffic light waiting time shorter than the traffic light waiting time of the 12 minutes, as an optimal route.

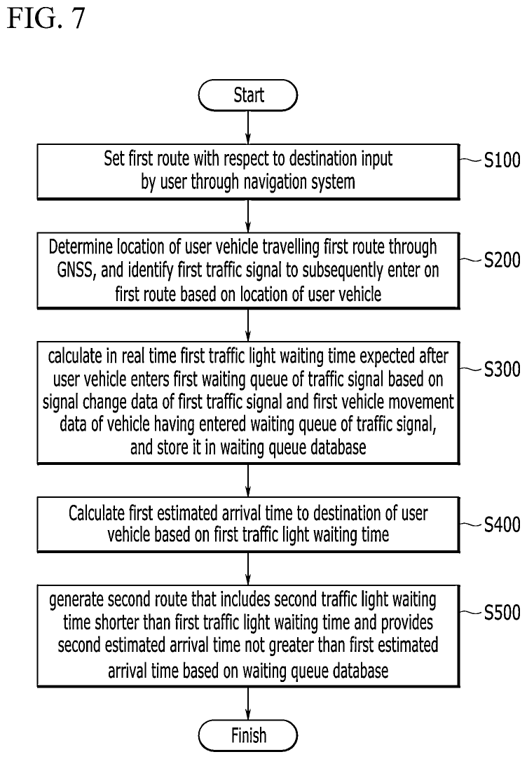

FIG. 7 is a flowchart of a method for generating a route considering a traffic light waiting time according to an embodiment. A method for generating a route considering a traffic light waiting time may be performed by the route generating apparatus 100 (refer to FIG. 1, hereinafter, route generating apparatus) considering the traffic light waiting time.

In FIG. 7, at operation S100, the route generating apparatus 100 may set the first route with respect to the destination input by the user through the navigation system.

At operation S200, the route generating apparatus 100 may determine the location of the user vehicle travelling on the first route by using the GNSS and identify the first traffic signal to be subsequently entered on the first route based on the location of the user vehicle. The route generating apparatus 100 may determine the location of the user vehicle on a lane-by-lane basis through precise positioning and the map matching method based on the GNSS.

At operation S300, the route generating apparatus 100 may calculate in real time the first traffic light waiting time expected after the user vehicle enters the waiting queue of the first traffic signal based on the signal change data for the first traffic signal and the vehicle movement data of vehicles having entered the waiting queue of the first traffic signal, and store it in the waiting queue database DB.

The waiting queue database may collect information on the plurality of traffic signals on the first route and the second route and the waiting queue information on each of the plurality of traffic signals from a plurality of vehicles, and store it in real time.

The waiting queue information on each of the plurality of traffic signals may include the green light waiting queue information, the left-turn light waiting queue information, and the right-turn light waiting queue information of each of the plurality of traffic signals.

In an embodiment, the route generating apparatus 100 may calculate in real time the first traffic light waiting time for the one waiting queue guided on the first route among the green light waiting queue, the left-turn light waiting queue, and the right-turn light waiting queue of the first traffic signal.

At operation S400, the route generating apparatus 100 may calculate the first estimated arrival time for the destination of the user vehicle based on the first traffic light waiting time.

The route generating apparatus 100 may, when the calculated first traffic light waiting time is greater than the reference traffic light waiting time by the preset criterion, determine that the delay time has occurred in the waiting queue, and calculate the first estimated arrival time by using or reflecting the delay time.

The route generating apparatus 100 may update the calculated first estimated arrival time, and provide notification about the waiting queue of the first traffic signal and the delay time occurring in the waiting queue to the user through the navigation system.

At operation S500, the route generating apparatus 100 may generate the second route including the second traffic light waiting time shorter than the first traffic light waiting time and providing the second estimated arrival time not later than the first estimated arrival time based on the waiting queue database DB.

In an embodiment, the route generating apparatus 100 may detect the second traffic light waiting time for remaining waiting queues excluding the one waiting queue of the first traffic signal from the waiting queue database, compare it with the first traffic light waiting time, and generate the second route.

In an embodiment, the route generating apparatus 100 may extract a plurality of second traffic signals having the second traffic light waiting time shorter than the first traffic light waiting time for the waiting queue of the first traffic signal on the plurality of routes to the destination.

The route generating apparatus 100 may generate a route to subsequently enter one second traffic signal located on the second route providing the second estimated arrival time among the extracted plurality of second traffic signals.

When the delay time occurs due to the first traffic light waiting time on the first route, the route generating apparatus 100 may provide a notification for guiding the second route as the recommended route may as well as a notification about the delay time.

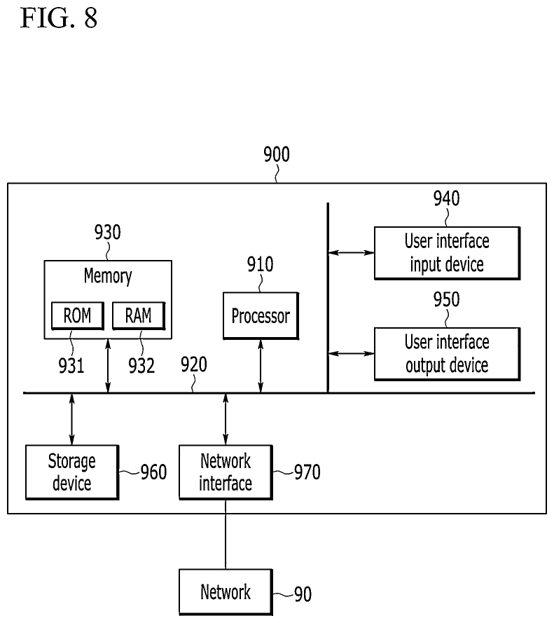

FIG. 8 is a drawing for explaining a computing device according to an embodiment.

Referring to FIG. 8, an apparatus and method for generating a route considering a traffic light waiting time according to an embodiment may be implemented by using a computing device 900.

The computing device 900 may include at least one of a processor 910, a memory 930, a user interface input device 940, a user interface output device 950 and a storage device 960 that communicate through a bus 920, any and all of which may be in plural. The computing device 900 may also include a network interface 970 electrically connected to a network 90, any and all of which may be in plural. The network interface 970 may transmit or receive signals with other entities through the network 90.

The processor 910, which may be in plural, may be implemented in various types such as a micro controller unit (MCU), an application processor (AP), a central processing unit (CPU), a graphic processing unit (GPU), a neural processing unit (NPU), and the like, or any combination thereof, and may be any type of semiconductor device capable of executing instructions stored in the memory 930 or the storage device 960. The processor 910 may be configured to implement the functions and methods described above with respect to FIG. 1 to FIG. 7.

The memory 930 and the storage device 960, either or both of which may be in plural, may include various types of volatile or non-volatile storage media. For example, the memory may include read-only memory (ROM) 931 and a random-access memory (RAM) 932. In this embodiment, the memory 930 may be located inside or outside the processor 910, and the memory 930 may be connected to the processor 910 through various ways.

In some embodiments, at least some configurations or functions of an apparatus and method for generating a route considering a traffic light waiting time according to an embodiment may be implemented as a program, code, or software including data and instructions executable by the computing device 900, and such program, code, or software may be stored in a computer-readable medium, for example.

In some embodiments, at least some configurations or functions of an apparatus and method for generating a route considering a traffic light waiting time according to an embodiment may be implemented by using hardware or circuitry of the computing device 900, or may also be implemented as separate hardware or circuitry that may be electrically connected to the computing device 900.

While this disclosure has been described in connection with what is presently considered to be practical embodiments, it can be understood that embodiments of the present disclosure are not necessarily limited to the disclosed embodiments, but, on the contrary, the present disclosure is intended to cover various modifications and equivalent arrangements included within the spirit and scope of the appended claims.

What is claimed is:

1. An apparatus for generating a route considering a traffic light waiting time, the apparatus comprising:
a route setting unit configured to set a first route for a destination input by a user through a navigation system;
a vehicle location determining unit configured to determine a location of a user vehicle travelling on the first route by using satellite system information, and identify a first traffic signal to be subsequently entered on the first route based on the location of the user vehicle;
a traffic light waiting time prediction unit configured to determine in real time a first traffic light waiting time expected after the user vehicle enters the waiting queue of the first traffic signal based on a signal change data for the first traffic signal and a vehicle movement data of vehicles having entered a waiting queue of the first traffic signal, and store the determined first traffic light waiting time in a waiting queue database;
an estimated arrival time determining unit configured to determine a first estimated arrival time for a destination of the user vehicle based on the first traffic light waiting time; and
a route generating unit configured to generate a second route having a second traffic light waiting time shorter than the first traffic light waiting time and having a second estimated arrival time not later than the first estimated arrival time based on the waiting queue database.

2. The apparatus of claim 1, wherein the vehicle location determining unit is configured to determine the location of the user vehicle on a lane-by-lane basis through precise positioning and a map matching method based on the satellite system information.

3. The apparatus of claim 1, wherein the waiting queue database is configured to collect information on a plurality of traffic signals on the first route and the second route, collect waiting queue information on each of the plurality of traffic signals from a plurality of vehicles, and store the collected information in real time.

4. The apparatus of claim 3, wherein the waiting queue information on each of the plurality of traffic signals includes straight light waiting queue information, left-turn light waiting queue information, and right-turn light waiting queue information of each of the plurality of traffic signals.

5. The apparatus of claim 4, wherein the traffic light waiting time prediction unit is configured to determine in real time the first traffic light waiting time for one waiting queue guided on the first route among a straight light waiting queue, a left-turn light waiting queue, and a right-turn light waiting queue of the first traffic signal.

6. The apparatus of claim 5, wherein the route generating unit is configured to retrieve the second traffic light waiting time with respect to remaining waiting queues, excluding the one waiting queue of the first traffic signal, from the waiting queue database and compare the retrieved second traffic light waiting time with the first traffic light waiting time.

7. The apparatus of claim 1, wherein the route generating unit is configured to:
extract a plurality of second traffic signals having the second traffic light waiting time shorter than the first traffic light waiting time for the waiting queue of the first traffic signal, on a plurality of routes to the destination; and
provide a route to subsequently enter one second traffic signal located on the second route providing the second estimated arrival time among the extracted the plurality of second traffic signals.

8. The apparatus of claim 1, wherein the estimated arrival time determining unit is configured to, in response to the determined first traffic light waiting time being greater than a reference traffic light waiting time by a preset criterion, determine that a delay time has occurred in the waiting queue, and determine the first estimated arrival time by including the delay time.

9. The apparatus of claim 8, wherein the estimated arrival time determining unit is configured to update the first estimated destination arrival time by using the determined estimated destination arrival time, and provide first notification about the waiting queue and the delay time occurring in the waiting queue to the user through the navigation system.

10. The apparatus of claim 9, wherein the route generating unit is configured to, in response to the delay time being determined, provide a second notification for guiding the second route as a recommended route together with the first notification to the user.

11. A method for generating a route considering a traffic light waiting time, the method comprising:
setting a first route for a destination input by a user through a navigation system;
determining a location of a user vehicle travelling on the first route by using a satellite system information;
identifying a first traffic signal to be subsequently entered on the first route based on the location of the user vehicle;
determining a first traffic light waiting time expected after the user vehicle enters the waiting queue of the first traffic signal based on signal change data for the first traffic signal and a vehicle movement data of vehicles having entered a waiting queue of the first traffic signal;
storing the determined first traffic light waiting time in a waiting queue database;
determining a first estimated arrival time for the destination of the user vehicle based on the first traffic light waiting time; and
generating a second route having a second traffic light waiting time shorter than the first traffic light waiting time and a second estimated arrival time not later than the first estimated arrival time based on the waiting queue database.

12. The method of claim 11, wherein the determining the location of the user vehicle comprises determining the location of the user vehicle on a lane-by-lane basis through precise positioning and a map matching method based on the satellite system information.

13. The method of claim 11, further comprising:
collecting information on a plurality of traffic signals on the first route and the second route;
collecting waiting queue information on each of the plurality of traffic signals from a plurality of vehicles; and
storing the collected waiting queue information.

14. The method of claim 13, wherein the waiting queue information on each of the plurality of traffic signals includes straight light waiting queue information, left-turn light waiting queue information, and right-turn light waiting queue information of each of the plurality of traffic signals.

15. The method of claim 14, wherein the determining of the first traffic light waiting time comprises determining the first traffic light waiting time for one waiting queue guided on the first route among a straight light waiting queue, a left-turn light waiting queue and a right-turn light waiting queue of the first traffic signal.

16. The method of claim 15, wherein the generating the second route comprises:
retrieving the second traffic light waiting time for remaining waiting queues, excluding the one waiting queue of the first traffic signal, from the waiting queue database; and
comparing the retrieved second traffic light waiting time with the first traffic light waiting time.

17. The method of claim 11, wherein the generating the second route comprises:
extracting a plurality of second traffic signals having the second traffic light waiting time shorter than the first traffic light waiting time for the waiting queue of the first traffic signal, on a plurality of routes to the destination; and
providing a route to subsequently enter one second traffic signal located on the second route providing the second estimated arrival time among the extracted the plurality of second traffic signals.

18. The method of claim 11, wherein the determining the first estimated arrival time comprises:
determining, in response to the determined first traffic light waiting time being greater than a reference traffic light waiting time by a preset criterion, that a delay time has occurred in the waiting queue; and
determining the first estimated arrival time by including the delay time.

19. The method of claim 18, wherein the determining the first estimated arrival time further comprises:
updating the existing estimated destination arrival time by using the determined estimated destination arrival time; and
providing a first notification about the waiting queue and the delay time occurring in the waiting queue to the user through the navigation system.

20. The method of claim 19, wherein the generating the second route comprises, in response to the determining that the delay time occurred, providing a second notification for guiding the second route as a recommended route together with the first notification to the user.
